(19) United States
(12) Patent Application Publication
(10) Pub. No.: US 2005/0028609 A1
(43) Pub. Date: Feb. 10, 2005

(54) Flow-monitoring method and device

(76) Inventors: Peter J. Langemann, Coaldale (CA); Kenneth R. Craig, Lethbridge (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/892,220

(22) Filed: Jul. 16, 2004

Related U.S. Application Data
(60) Provisional application No. 60/487,611, filed on Jul. 17, 2003.

(30) Foreign Application Priority Data
Jul. 17, 2003 (CA) 2,435,560

(51) Int. Cl. G01F 1/28

(52) U.S. Cl. 73/861.74

(57) ABSTRACT

A flow-monitoring method and device for measuring the flow of fluid through a conduit such as a pipeline or open channel. More particularly, the present invention relates to a method and device for monitoring fluid flow for metering purposes. In one embodiment, the device includes a sensor system in communication with a counter system. In a further embodiment, the sensor system includes a vane moveable between an activated and a deactivated position. When fluid flows past the vane, the vane is moved into an activated position and the sensor system in turn activates the counter system for recording the length of time during which fluid is being supplied through the pipeline or channel. When fluid is no longer supplied, the vane reverts to a deactivated position which signals the sensor system to turn off the counter system.

### CROSS-REFERENCE TO RELATED APPLICATIONS

This application claims the benefit of U.S. patent application Ser. No. 60/487,611, filed Jul. 17, 2003, which is incorporated herein by reference in its entirety.

### FIELD OF THE INVENTION

The present invention relates generally to a flow-monitoring method and device for recording the duration of the flow of fluids through a conduit such as a pipeline or open channel. More particularly, the present invention relates to a method and device for monitoring water or liquid flow for metering purposes.

### BACKGROUND OF THE INVENTION

It is generally desirable for businesses and organizations supplying fluids such as water or other liquids through pipeline systems or channels to be able to accurately and cost effectively measure the quantities they provide to be able to charge recipients of the supplied fluids appropriately. More specifically, it is becoming increasingly important to quantify the amount of water provided to individuals and businesses through supply systems as the demand for water, a scarce resource, increases.

Many suppliers of fluids through pipelines or channels or other supply systems can readily and easily quantify the rate of flow through a supply system. For example, suppliers can measure rate of flow by measuring the capacity of the application of the supply system (for example, by measuring the output of pumps or sprinkler heads). Accordingly, if suppliers can accurately measure the total time that the supply system is supplying fluid, the supplier can easily compute the total amount of fluid provided to the recipient if the rate of flow through the supply system is known. That is, using the formula rate of flow x duration of flow a supplier can determine the total amount of fluid provided to the recipient.

The prior art provides various flow-measuring systems which attempt to continuously measure the rate of flow of water or fluid. Many of these prior art flow-measuring systems are installed in larger sites and are not designed for or effective in measuring or metering fluid flow and typically require finely-tuned parts to continuously measure flow for determining total flow for a specific time period.

Further, many prior art systems require high upkeep, have high power requirements, are not portable or have a high initial cost.

Another problem experienced by prior art flow-measuring systems is that they may come into contact with foreign material including silt, algae and other debris, especially systems located in open canals. The foreign material in open canals makes conventional flow measurement at diversion points and farm turnouts difficult and usually requires very expensive screening of the water. Many prior art systems therefore either require expensive screening or fail to work efficiently (or at all) as time passes and the collection of foreign material increases.

It is, therefore, desirable to provide an efficient and cost effective device and method for metering fluid flow through a conduit that can operate in environments with or without foreign material.

### SUMMARY OF THE INVENTION

It is an object of the present invention to overcome the disadvantages of previous flow-monitoring methods and devices. In particular, it is an object of the present invention to provide a method and device which can be cost effectively installed and used for measuring small or individual fluid supplies. A further object of the present invention is to provide a device which operates effectively notwithstanding the presence of foreign material in the fluid supply.

It is a further object of the present invention to provide a method and device that is inexpensive, durable, has lower power requirements and can be installed and will operate with minimum maintenance.

It is a still further object of the present invention to provide a vane optimally designed for the present invention but operable for flow measuring and flow switch devices generally.

In one embodiment of the present Invention, the present invention includes a sensor system in fluid communication with the water or fluid for determining when water or fluid is being flowed through the pipeline or channel. The present invention further includes a counter system which communicates with the sensor system. The counter system is activated upon reception of a signal from the sensor system when the sensor system determines that water or fluid is being flowed through the pipeline or channel. Once activated, the counter system measures the length of time during which the counter system is activated, such measurements used to calculate total flow.

Other aspects and features of the present invention will become apparent to those ordinarily skilled In the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a perspective view of a flow-monitoring device in accordance with the present invention;

FIG. 2 is a side sectional view of a flow-monitoring device installed in a pipeline system in accordance with the present invention;

FIG. 3 is an end view of a flow-monitoring device installed in a pipeline system in accordance with the present invention;

FIG. 4 is a perspective view of a vane for use in a pipeline system in accordance with the present invention;

FIG. 5 Is a perspective view of a vane in accordance with the present invention;

FIG. 6 is a perspective view of a vane for use in an open channel in accordance with the present invention;

FIG. 7 is a side view of a flow-monitoring device without a counter system installed on a turnout gate leaf in accordance with the present invention;

FIG. 8 is a side view of a flow-monitoring device installed in a channel with flow in accordance with the present invention; and

FIG. 9 is a schematic of a flow-monitoring method in accordance with the present invention.

### DETAILED DESCRIPTION

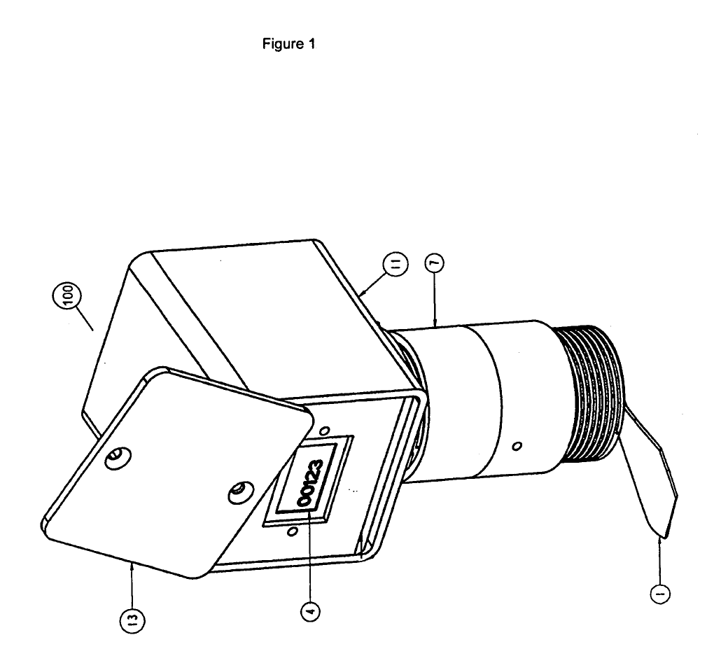

Generally, the present invention provides a method and device for monitoring the flow of fluids through a pipeline 82, channel 83 or other supply or conduit system. With reference to FIG. 1, a flow-monitoring device 100 includes a sensor system 70 and a counter or metering system 11 which includes a memory (not shown), record-making means (not shown) and a clock or elapsed-time measuring means 4. The device 100 is installed and positioned in a closed pipeline 82 or an open channel 83 such that when water or fluid is flowing through the pipeline 82 or channel 83, the sensor system 70 will be in fluid communication with the fluid supply. In general operation, when the fluid is flowed through the pipeline or the channel, the sensor system 70, in communication with the counter system 11, will activate the counter system 11. The counter system 11 records the amount of time during which the counter system 11 is activated (which has the effect of metering the time during which the fluid is supplied or flowing through the pipeline or channel). This may be done by recording flow start and flow stop times and calculating the differential, or by counting elapsed time as it elapses, and recording the time elapsed during the “flow-on” state reported by the sensor system while activated by the fluid's flow. Once the supply of fluid through the system is restricted or stopped, the sensor system 70 detects that there is no more supply of fluid and deactivates the counter system 11. By simply registering or calculating the length of time the supply of fluid was supplied through the supply system, an operator, knowing the rate of flow of fluid flowing through the pipeline or channel, can quite easily calculate and measure the total amount of fluid provided through the pipeline 82 or channel 83 using the formula: rate of flow×duration of flow.

In one embodiment, the counter system 11 and the sensor system 70 are integrated in one system. In another embodiment, the counter system 11 and sensor system 70 are in operative communication through the use of wire means or wireless means for allowing an operator to place the counter system 11 in a more convenient location, remote from the sensor system 70.

In another embodiment the counter system 11 may include means for transmitting or reporting results to a central server (not shown) such that a group or collection of counter systems 11 could be monitored and their results consolidated or reported.

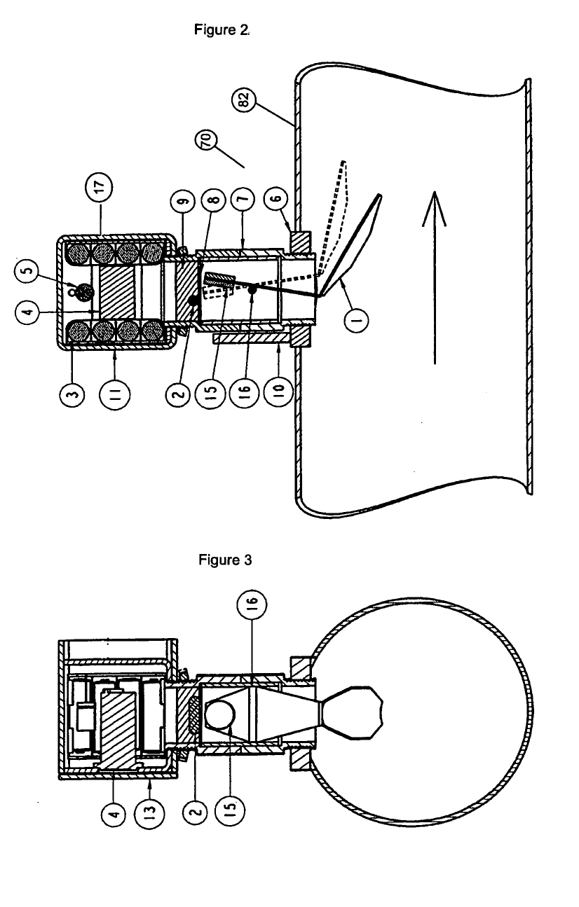

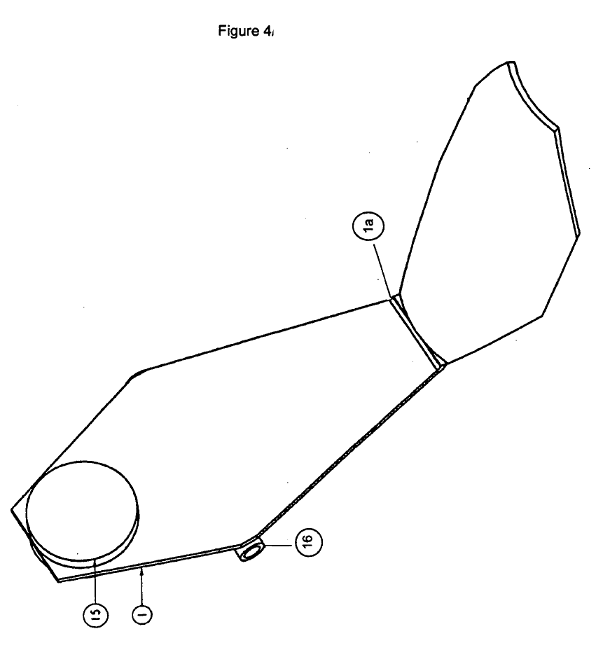

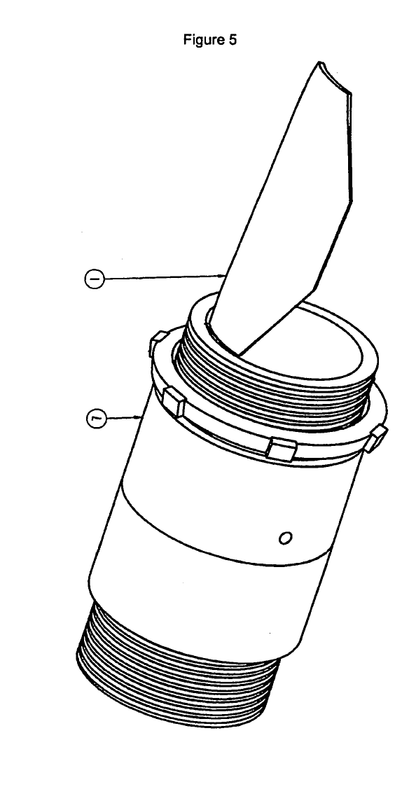

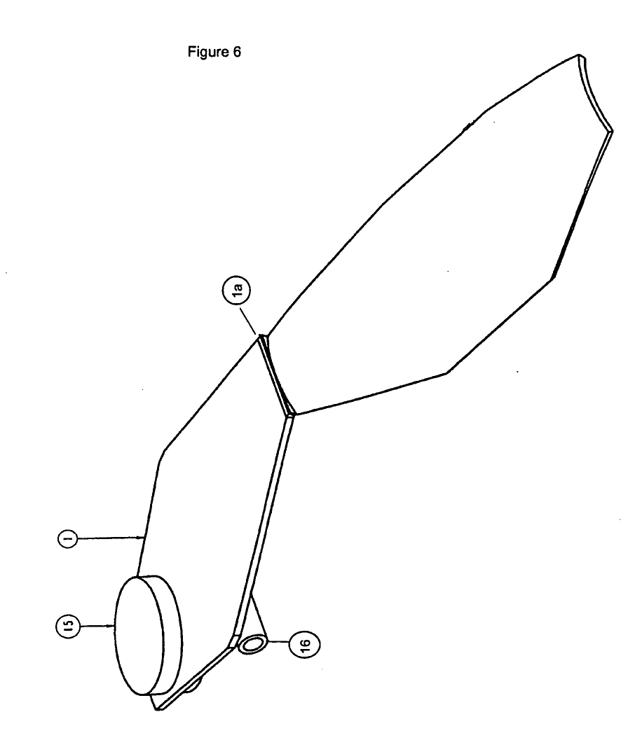

In one embodiment the sensor system 70 includes a vane 1 which protrudes into the pipeline or channel or other conduit. The vane 1 is pivotable between two positions, namely an activated position and a default deactivated position. The vane 1 further includes a magnet 15 as best shown in FIG. 6. When water or liquid is supplied through the pipeline or channel, the vane 1 is forced to pivot into the activated position, as shown by the dotted lines in FIG. 2, at which time the magnet activates the counter system 11. When water or liquid is no longer supplied, the vane 1 reverts to the default disengaged position thereby removing the magnet from the vicinity of the counter system 11 resulting in the counter system 11 being turned off. A worker skilled in the art will appreciate that the vane 1 may be composed of any suitable flexible or rigid material for use within in a pipeline or channel including metal, plastic, rubber or composite materials.

Although a worker skilled in the art will also appreciate that the vane 1 may be formed in various shapes, In a preferred embodiment the vane 1 is shaped as shown in FIG. 4 (pipeline installation) and FIG. 6 (open channel Installation). More specifically, the vane 1 is an elongate member having a bend 1a. The bend 1a is placed within the housing 7 of the sensor system 70. The vane 1 is positioned such that a minimum amount of flow will move the vane 1 into an activated position. The end of the vane 1 after the bend 1a (referred to as the bend end 1b) which protrudes into the pipeline or channel has a rounded surface to prevent foreign material from lodging on the vane 1 or otherwise preventing the vane 1 from operating. In a further embodiment in a pipeline installation, bend end 1b may be curved such that when the vane 1 is in the activated position it corresponds to the interior curvature of the pipeline and is, accordingly, exposed to minimum flow to reduce exposure to foreign material. In a still further embodiment, the profile of the face of the vane presents rounded leading edger to fluid flow to reduce exposure of the vane to foreign debris.

A worker skilled in the art will appreciate that this vane could also be used in flow measuring and flow switch devices which make use of a vane.

In one embodiment, the device 100 includes a switch 2 which is normally open and which is magnetically activated when the vane 1 pivots about pivot shaft 16 into the activated position which places the magnet 15 in the proximity of the switch 2 thereby closing an electrical circuit. The switch 2, once activated, activates the counter system 11 for recording the amount of time during which the counter system 11 is activated (which in turn meters the length of time water or liquid is supplied through the pipeline or channel). In a further embodiment, the switch 2 is a magnetically activated double throw switch or reed switch.

In another embodiment, the counter system 11 cannot be reset, to prevent tampering of the counter system 11, especially by individuals who are having their fluid metered. The counter system 11 may include a cover plate 13 for covering the clock 4 for preventing tampering. In another embodiment, the sensor system 70, the counter system 11 or both systems are installed in a tamper-proof or tamper-evident way to ensure that the counter system's rendered data is reliable and to indicate when the data may not be reliable as a result of the counter system 11 being tampered with. In a more specific embodiment for use with a pipeline, security tape is wrapped around the counter system 11 and a rod or other protrusion 10 welded to the pipeline to ensure that any attempt to tamper with the counter system 11 is readily recognized. In a more specific embodiment for use with an open channel, the counter system 11 may be mounted or located in a remote and inaccessible location.

In addition to providing a tamper-proof housing, the present invention may also include an external housing 17 designed to ensure that the counter system 11 is protected from environmental elements. The external housing may be insulated from the sensor system 70 using plate 8 and urethane potting 9 as best shown in FIG. 2 to ensure that the system is waterproof. Housing 7 may be connected to half coupling 6 also shown in FIG. 2 for further ensuring the waterproof and tamperproof features of the present invention.

In other embodiments, the counter system 11 may provide additional functions. For example, the counter system 11 may record the times when the sensor system 70 was activated (that is, when water or fluid was being provided through the delivery system). In still another embodiment, the clock 4 may monitor the time during which the counter system 11 is activated. In a further embodiment, the clock 4 has a low power requirement and may operate using batteries 3 as a power supply.

In one embodiment as shown In FIG. 2 the counter system 11 includes a capacitor 5 to condition the power with some clocks 4.

In one embodiment designed to reduce the device's power requirements, the sensor system 70 turns the counter system 11 on and off and the counter system 11 only records when the counter system 11 is turned on. A worker skilled in the art will appreciate that in this embodiment, the power required to operate the counter system 11 is minimal since power is only required when water or liquid is provided through the pipeline or channel. Accordingly, the use of batteries 3 as a power supply is sufficient to operate the flow-monitoring device 100 for a number of years.

In another embodiment, the sensor system 70 continually provides an activated or deactivated signal to the counter system 11 thereby allowing the counter system 11 to determine if the counter system 11 should be recording flow through the supply system.

In some circumstances, the device 100 may be installed in a remote location or in a location that is difficult to access. In these circumstances, the device 100 may include a transmitting or transceiving unit (not shown) for remotely providing measurements recorded by the counter system 11. In another embodiment, the transmitting or transceiving unit may be incorporated with the counter system 11. In yet another embodiment, the sensor system 70 may include a transmitting or transceiving unit for activating the counter system 11 which may be more conveniently placed, as shown in FIG. 8.

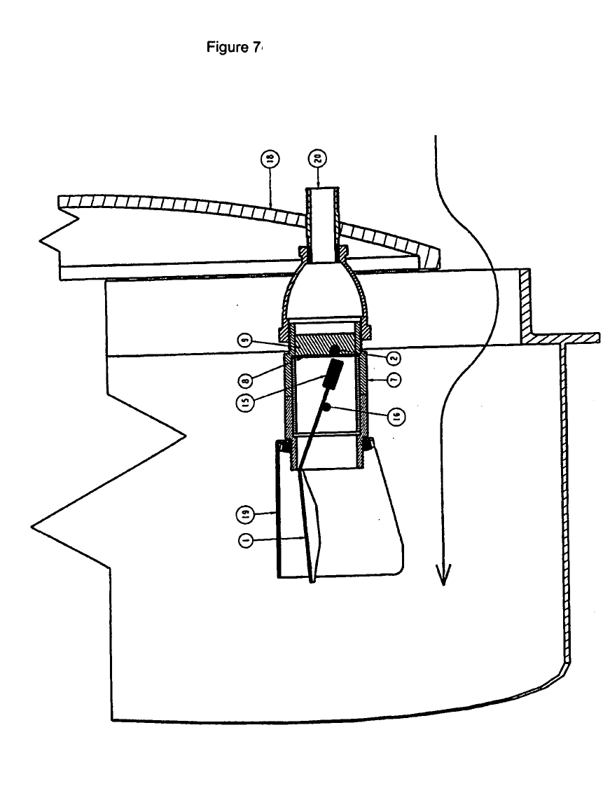

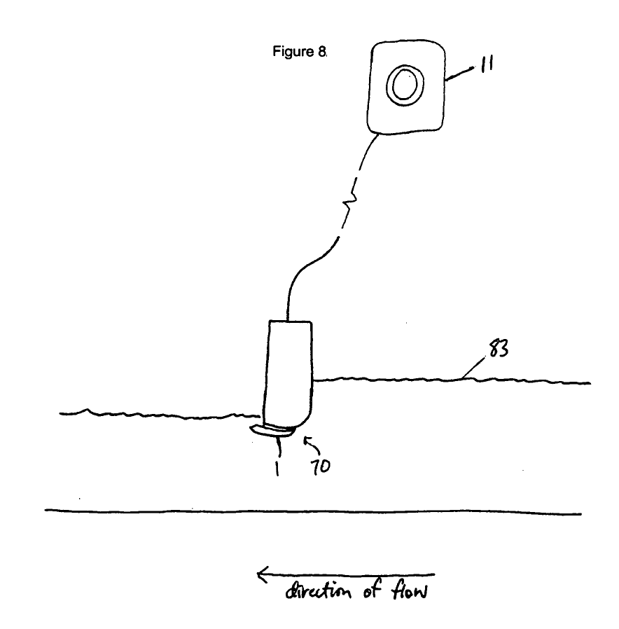

In one embodiment, the present invention is installed in a pipeline or channel for individual metering. A specific example of individual metering is measuring the quantity of water supplied to agricultural irrigators. The present invention may be installed at a turnout gate 18 as shown in FIG. 7 thereby allowing the supplier to accurately infer the amount of water used by an individual irrigator, who would be assumed to have used water at a flow rate optimal to his particular irrigation devices. Water usage patterns of the irrigator may then be inferred by using time-based measurement of flow-on versus flow-off, rather than more complex flow rate or volumetric measurements.

In one embodiment, the flow-monitoring device is installed horizontally in an open canal as shown in FIG. 7 to prevent tampering and to make the flow-monitoring device 100 impervious to foreign matter. In this embodiment, the vane 1 may be protected by a hood or shroud 19. The device may include an NPT nipple 20 for installing the device through the turnout gate 18.

In any of the embodiments described above, the battery 3 may be of any type known to those skilled in the art, including disposable or rechargeable batteries of varying voltages. The battery may be recharged by a mechanical generator powered by the fluid flow, or by solar panel, wind-mail or similar external energy sources.

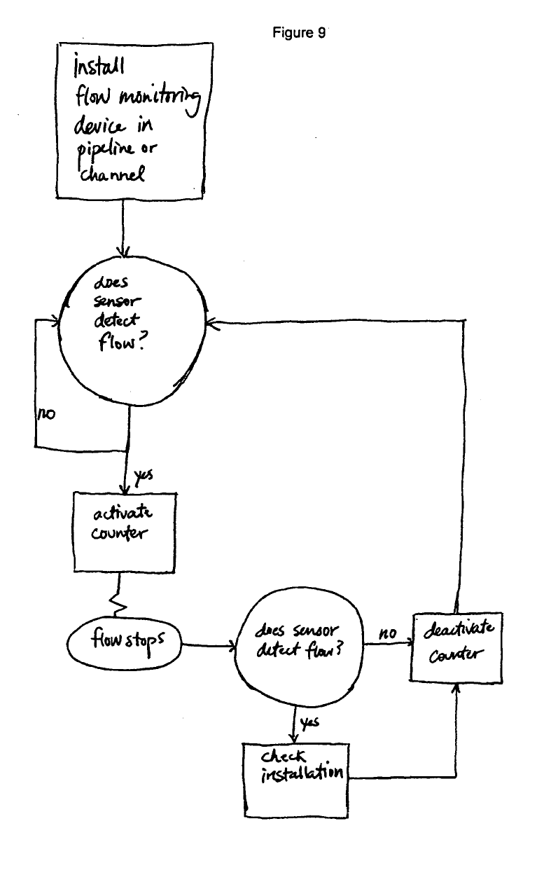

One method of measuring flow in a pipeline or in a channel using the device 100 is shown in FIG. 9. More specifically, once the flow-monitoring device 100 is properly installed, the device 100 is in a standby mode. When water or liquid is subsequently provided through the pipeline or channel, the vane 1 is moved into an activated position thereby activating the sensor system 70 (more specifically when magnet 15 activates switch 2) which in turn activates the counter system 11. Counter system 11 then records the duration during which the counter system 11 is turned on or measures and records “on” and “off” flow state change times and calculates elapsed time “on”. When the flow through the pipeline or channel stops, the vane 1 reverts to a default disengaged position thereby causing the sensor system 70 to turn off the counter system 11 and resetting device 100 to standby mode.

A worker skilled in the art will appreciate that the device is capable of measuring any fluid flowing through a conduit. That is, while the fluid may be water or some other type of liquid flowing through a pipeline or channel, the fluid may also be gas, slurry or a combination of fluids which are capable of flowing through a pipeline, channel or other conduit.

The above-described embodiments of the present invention are intended to be examples only. Alterations, modifications and variations may be effected to the particular embodiments by those of skill in the art without departing from the scope of the invention, which is defined solely by the claims appended hereto.

1. A device for measuring flow of fluid through a conduit comprising:
a sensor system in fluid communication with the fluid for determining when fluid is being flowed through the conduit; and
a counter system in operative communication with the sensor system, the counter system for measuring the length of time during which the counter system is activated.

2. A device as in claim 1 wherein the sensor system is activated and activates the counter system when the fluid is being flowed through the conduit and the sensor system is deactivated and deactivates the counter system when the fluid is no longer being flowed through the conduit.

3. A device as in claim 2 wherein the counter system records the duration during which the counter system is turned to measure the length of period during which the fluid was flowed through the conduit.

4. A device as in claim 1 wherein the sensor system is activated and sends an “on” signal to the counter system when the fluid is being flowed through the conduit and the sensor system is deactivated and sends an “off” signal to the counter system when the fluid is no longer being flowed through the conduit.

5. A device as in claim 4 wherein the counter timestamps each “on” and “off” signal received from the sensor system for calculating the amount of time elapsed between each “on” and “off” signal.

6. A device as in claim 5 wherein the counter adds all of the time elapsed between “on” and “off” signal received from the sensor system to determine the total time during which the fluid was flowing through the conduit.

7. A device as in claim 2 wherein the sensor system includes a vane in fluid communication with the fluid, the vane operable between an activated and a default deactivated position, the vane activating the sensor system when fluid flow moves the vane into the activated position and the vane deactivating the sensor system when fluid is no longer supplied through the conduit and the vane reverts to the deactivated position.

8. A device as in claim 5 wherein the vane includes a magnet and the sensor system includes a magnetically activated switch such that when the vane is moved into an activated position the magnet activates the switch to turn on the sensor system which in turn activates the counter system.

9. A device as in claim 8 wherein the end of the vane protruding into the conduit is circular to prevent foreign material from lodging on the vane.

10. A device as in claim 5 wherein the end of the vane is tapered for reducing the amount of flow resistance caused by the vane.

11. A device as in claim 10 wherein the conduit is a pipeline and the vane has a curvature for corresponding to the shape of the interior surface of the pipeline into which the vane nests when the vane is in the activated position.

12. For placement into a conduit a vane which is movable between an activated position upon fluid flowing through the conduit and a deactivated position upon no fluid flowing through the conduit the vane having:
an end view profile corresponding to the shape of the interior surface of the conduit into which the vane nests when the vane is in the activated position.

13. A vane as in claim 12 wherein the profile of the face of the vane presents rounded leading edges to the direction of fluid flow to reduce fouling of the vane by foreign debris flowing through the conduit when the vane is in the activated position.

14. A device for measuring the flow of fluid through a conduit comprising:
a sensor system for determining when fluid is being supplied through the conduit, the sensor system including a vane in fluid communication with the fluid, the vane operable between an activated and a default deactivated position, the vane activating the sensor system when fluid flow moves the vane into the activated position and the vane deactivating the sensor system when fluid is no longer supplied through the conduit and the vane reverts to the deactivated position; and
a counter system in operative communication with the sensor system, the counter system being activated upon reception of a signal from the sensor system when the sensor system is activated by the vane and the counter system being deactivated when the sensor system is deactivated by the vane, the counter system for measuring the length of time during which the counter system is activated.

15. A device as in claim 14 wherein the vane includes a magnet and the sensor system includes a magnetically activated switch such that when the vane is moved into an activated position the magnet activates the switch to turn on the sensor system which in turn activates the counter system.

16. A method of measuring the flow of fluid through a conduit comprising the steps of: installing the device of claim 1; and
multiplying the length of time measured in the counter system by the expected flow rate of fluid through the conduit to calculate an inferred volume of fluid flowed through the conduit.

17. A method of measuring the flow of fluid through a conduit comprising the steps of: installing the device of claim 3; and
multiplying the length of time measured in the counter system by the expected flow rate of fluid through the conduit to calculate an inferred volume of fluid flowed through the conduit.

18. A method of measuring the flow of fluid through a conduit comprising the steps of: installing the device of claim 6; and
multiplying the length of time elapsed between each “on” and “off” signal by the expected flow rate of fluid through the conduit to calculate an inferred volume of fluid flowed through the conduit.
